(19) United States
(12) Patent Application Publication
(10) Pub. No.: US 2014/0318950 A1
(43) Pub. Date: Oct. 30, 2014

(54) SYSTEM AND REACTOR VESSEL FOR TREATMENT OF FLUID MEDIUM CONTAINING BIOLOGICAL MATTER

(71) Applicant: DECANT TREATMENT SYSTEMS LLC, Cherry Hill, NJ (US)

(72) Inventors: Leonid MOLDAVSKY, Nazareth-Illit (IL); Matitiahu FICHMAN, Haifa (IL)

(73) Assignee: DECANT TREATMENT SYSTEMS LLC, Cherry Hill, NJ (US)

(21) Appl. No.: 13/870,611

(22) Filed: Apr. 25, 2013

(51) Int. Cl. C02F 1/46

(52) U.S. Cl. CPC C02F 1/4608
USPC 204/225

(57) ABSTRACT

A system and reactor vessel for electrical treatment of a fluid medium are described. The fluid medium to be treated comprises various industrial or domestic waste waters. The reactor vessel is provided with a housing being closed from one side thereof by a removable closure carrying secured thereon electrodes. The electrodes are electrically connected to the source of electrical power, wherein the closure is adapted for assembling with and disassembling from the housing such that the closure could be conveniently separated from the reactor vessel together with the electrodes to provide easy access to electrodes for inspection, replacement, repair, cleaning or for other type of maintenance.

### FIELD OF THE INVENTION

The present invention refers in general to treatment of fluids containing biological matter for the purpose of their disinfection as well as for improving various environmental parameters of waste waters like for example Bio Oxygen Demand (BOD), Chemical Oxygen Demand (COD), Nitrogen Phosphor Potassium rating (N—P—K) and content of solids. The disinfection is ensured by virtue of applying electrical current to biologically contaminated fluid. The current destroys cells of biological matters and kills various pathogens contained therein. By virtue of such treatment the environmental parameters of intracellular material which is extracted from the fluid medium are improved.

In particular the present invention concerns a system and a reactor vessel for use with the system in which the above mentioned treatment can be carried out.

As an example of a fluid medium suitable for treatment by the present invention one can mention liquid waste waters originated from various industrial and agricultural installations, municipal sewage, waste waters originating from slaughter houses, from mining installations, fracturing waste waters, waste waters originating from food industry, from cosmetic industry, from pharmaceutical industry, etc.

By treatment of contaminated waste waters in the system and reactor vessel of the present invention it is possible to.

### BACKGROUND OF THE INVENTION

There are known methods of treatment of liquids containing biological matter by applying electrical current thereto.

So, for example in U.S. Pat. No. 6,141,905 there is described process and apparatus for utilizing animal excrement. According to this invention an aqueous mixture containing solid feed excrements from animals is subjected to treatment with an alternating electric current at a frequency of a predetermined magnitude and for a predetermined period of time, when the mixture passes through a tubular reactor.

In U.S. Pat. No. 6,344,349 there is disclosed process and system for electrical extraction of intracellular matter from biological waste materials, e.g. animal and human compost. The process comprises preparation of a mixture biological matter with electro conductive fluid and then passing thereof through a processor unit while electrifying the mixture by transmitting thereto controlled cycles of pulses and pauses of electrical current by means of flat electrodes located within a processor unit.

Both patents describe in details electrical parameters of the process and provide some schematic description of reactor vessel in which the treatment takes place without however providing detailed explanation of the reactor vessel construction.

Here by “reactor vessel” or simply “vessel” is meant any suitable tubular receptacle, container or reservoir defining a space through which flows fluid medium containing biological matter while this medium being treated by electrical current supplied by electrodes retrofitted within the reactor vessel. Such tubular receptacle can be defined either by circular or non-circular cross-section and it would be suitable either for continuous operation or for batch operation.

The reactor vessels used for treatment of various liquids containing organic matter are provided with electrodes for supplying electrical current and those electrodes usually are located inside the vessel.

One important parameter, which should be taken into consideration while designing suitable reactor vessel for electrical treatment is electrical conductivity of a liquid to be treated. Depending on this parameter one should properly select geometry of electrodes, their surface area, their amount as well as the distance between adjacent electrodes in order to ensure that the most efficient treatment in terms of capacity and environmental parameters could be achieved.

In WO 2008155315 there is described a device for cleaning and sterilizing fluids, in particular water. The device comprises elongated tubular container having an inlet and an outlet and a couple of flat electrodes installed within the container so as to be in the flow path of the fluid treated. According to the patent at least one electrode is coated with porous ceramic coating on the side facing the opposite electrode. The devices comprises also an impulse generator unit electrically connected to the electrodes and capable for applying to the fluid of pulsed coronal discharges with the filed strength of at least 100 kV/cm.

In US 2012000782 there is disclosed a uniform electrical field dielectric barrier discharge reactor for purifying of air, sterilizing of fluids or treatment of waste material. The reactor comprises an electrode unit, a dielectric catalyst container and an insulative housing. The electrode unit comprises electrode plates with discharge needles distributed on the insulative plane frame structure.

It can be appreciated that for treating of liquids having dissimilar electrical conductivity within the same reactor vessel different electrodes would be required and therefore it would be desirable that fast, convenient and simple access to the electrodes for their replacement and/or for maintenance could be possible. To conform to these requirements the construction of the electrodes and of the vessel should allow easy assembling and disassembling and there exist various attempts for providing such a possibility.

In some of the known reactors the electrodes are electrically connected to respective fittings which mechanically couple the electrodes to the cover. The fittings pass through the cover and protrude from the cover outside such that they can be electrically connected with a current source for feeding electrical current from the source to the electrodes. When the cover is removed and the fittings are loosened the electrodes can be evacuated from the reactor vessel for cleaning, maintenance or replacement. Fitting arrangement of this type can be found for example in JP 2000046627.

IN JP2000046627 is described electrode holder, which can be used for fixing an electrode holder to a reactor vessel.

In CN 102060357 there is disclosed electrolysis reactor for treatment of high salinity waste waters. The reactor is designed as a cylindrical tube through which passes central water inlet pipe. The reactor is provided with radially installed flat electrodes.

It is stated in the patent that the reactor can be assembled and disassembled, cleaned and maintained conveniently since all its parts are movable.

In CN 201623198 there is described cylindrical reactor for use in microbial fuel cell. The reactor is provided with a couple of flat electrodes immersed in the electro genesis substrate within the reactor. It is stated in the patent that the fuel cell has simple structure and low construction cost.

In JP 7299464 there is described multipurpose water treatment tank for sterilizing, cleaning and electrolyzing water. The tank is designed as a vessel of cylindrical configuration. The vessel is provided with a couple of concentric circular electrodes mounted to a cover such that they face each other. The electrodes are arranged in the water tank and the cover can be screwed to the vessel body to constitute non-diaphragm type electrolytic apparatus.

In CN 102437360 there is disclosed multi electrode microbial fuel cell comprising a housing accommodating therein detachable circular partition plates of different diameter and detachable circular electrode plates of different diameters. Both the circular plates and the circular electrodes divide the housing into cathode chamber and anode chamber and they can be disassembled.

In CN101187038 there is described reactor for fluorination and electrolysis, which comprises electro pads, negative and positive electrode terminals, negative and positive electrode fitted rods and a generator. It is stated in the patent that the reactor has simple construction, it can be conveniently assembled and disassembled and has high volume rate.

Thus it can be appreciated that despite of many attempts to design reactor vessels for treatment of liquids containing organic matter there still is felt a strong need in a new and improved system and reactor vessel, which would be suitable for efficient treatment of various liquid wastes and in particular would be suited for the peculiarities of extraction of intracellular matter from fluid biological waste materials.

### The objects of the invention

The main object of the present invention is to provide for a new and improved system and reactor vessel suitable for efficient extracting intracellular matter from waste waters containing organic matter by applying electrical current thereto, irrespective of the electrical conductivity of the waste waters to be treated.

The further object of the present invention is to provide for a new and improved system and reactor vessel, in which there is provided a possibility that upon demand the electrodes of the reactor vessel can be fast and easily replaced, repaired, cleaned or otherwise maintained.

### SUMMARY OF THE INVENTION

The above mentioned objects are achieved by providing the reactor vessel with a elongated tubular housing adapted for passing therethrough of the treated waste waters, said housing being closed by a cover carrying at least one couple of flat electrodes, which are separated by a distance D and have a surface area S, the electrodes being adapted for electrical connection with a source of electrical power, while the above parameters are calculated by the following formulae:

$$\begin{matrix}D = \frac{{V}_{0}}{{ρ}_{0} \cdot {I}_{0}} = \frac{{V}_{0}}{{ρ}_{0} \cdot {j}_{0} \cdot S} & ( 1 ) \\ S = \frac{{T}_{0} \cdot {Q}_{0}}{D} = {( \frac{{T}_{0} \cdot {Q}_{0} \cdot {ρ}_{0} \cdot {j}_{0}}{{V}_{0}} )}^{\frac{1}{2}} & ( 2 )\end{matrix}$$

wherein in the above formulae

V₀ is given voltage which is supplied by the source of electrical power during the treatment,

I₀ is electrical current which is supplied by the source of electrical power during the treatment,

j₀ is density of electrical current needed for the treatment, I₀/S,

T₀ is treatment time,

Q₀ is flow rate of the waste waters during the treatment,

ρ₀ is electrical resistance of the waste waters to be treated,

and the cover is adapted for assembling with and disassembling from the housing such that upon demand the cover could be conveniently separated from the reactor vessel together with the electrodes to provide easy access to its interior for electrodes replacement, repair, cleaning or for other type of maintenance.

### BRIEF DESCRIPTION OF THE DRAWINGS

FIG. 1 shows schematically a closed loop system for treatment of waste waters containing biological matter.

FIG. 2 is a photograph of a reaction vessel used with the system shown in FIG. 1.

FIG. 3 is a photograph of a top view of the reaction vessel shown in FIG. 2.

FIG. 4 is a photograph of a side view of the reaction vessel shown in FIG. 2.

FIG. 5 is a photograph of another top view of the reaction vessel shown in FIG. 2.

FIG. 6 is a photograph of a side view of the reaction vessel shown in FIG. 2.

FIG. 7 is a schematic presentation of a cross section of the reaction vessel shown in FIG. 2.

FIG. 8 is a photograph of a cover with electrodes when the cover is removed from a housing of the reaction vessel.

FIG. 9 is another photograph of the cover shown in FIG. 8.

FIG. 10 is a photograph of an upper portion of the cover showing an arrangement for electrical connection of the electrodes.

FIG. 11 is a schematic drawing of the reaction vessel shown in FIG. 2.

FIG. 12 is a cross-section of a fragment of the reaction vessel showing an arrangement of electrical connection of the electrodes with a source of voltage.

FIG. 13 is a schematic presentation of a pair of electrodes within the housing of the reactor vessel.

FIG. 14 is a schematic presentation of a flat electrode with a couple of pins for electrical connection to a source of voltage.

FIG. 15 is a schematic presentation of an arrangement for grounding the housing of the reactor vessel.

FIG. 16 is a schematic presentation of the reactor vessel provided with a couple of lateral flat electrodes and with a central electrode for connecting with a neutral.

FIG. 17 is a schematic presentation of the reactor vessel provided with two pair of lateral electrodes and with a central electrode being separated by a distance d.

FIG. 18 is a schematic presentation of disposition of several pair of electrodes within the housing of reactor vessel.

FIG. 19 is a schematic presentation of three reactor vessel connected in series.

FIG. 20. is a schematic presentation of three reactor vessel connected in sequence.

### DETAILED DESCRIPTION OF THE INVENTION

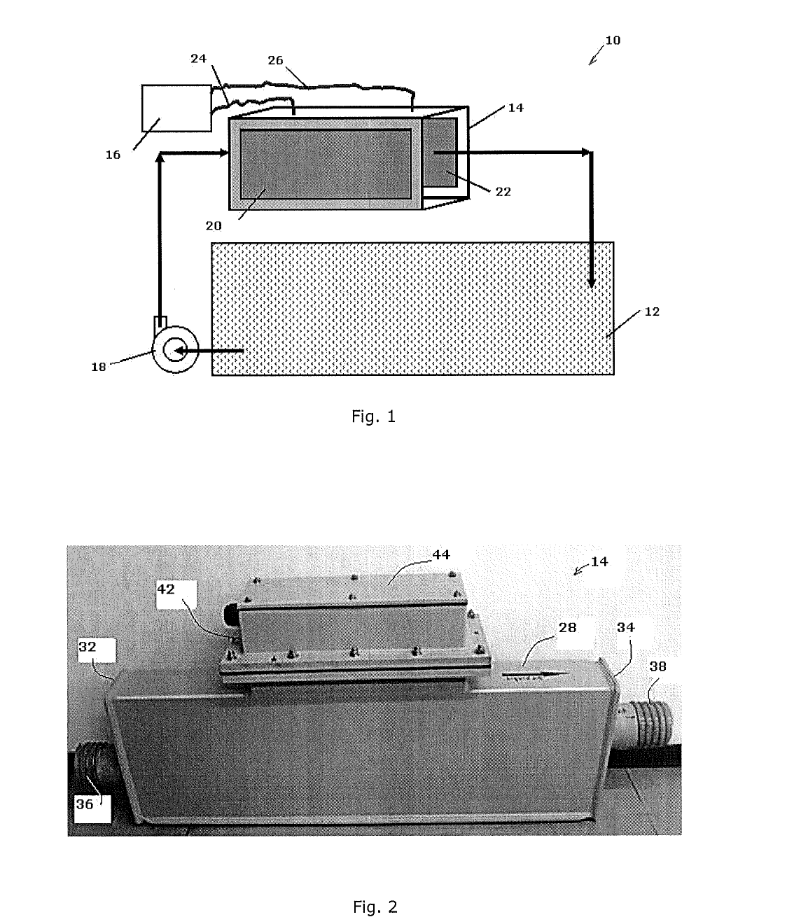

With reference to FIG. 1 it is presented in a very simplified manner a close loop system 10 used for treatment of a fluid medium containing biological matter, e.g. various pathogens. By applying electrical current to the fluid medium the pathogens are killed and then upon their extraction and evacuation the fluid medium is disinfected. An example of a suitable fluid medium which can be treated in the system of the present invention is waste waters, originated from various industrial and agricultural installations, municipal sewage waters, waste waters originating from slaughter houses, waste waters originated from mining installations, fracturing waste waters, etc.

The system comprises a reservoir 12 filled with the fluid medium to be treated, a reactor vessel 14, in which the treatment of the fluid medium takes place, a source of electric power with a control panel 16 and a pump 16. The source of electric power supplies alternating current with the required electrical parameters for the treatment of the fluid medium. The pump is required for supplying the fluid medium from reservoir to the reactor vessel and then, upon expiration of the treatment time from reactor vessel back to the reservoir. The direction of movement of the fluid medium is schematically designated by arrows and it can be seen that the fluid medium is forcibly displaced by the pump in the clockwise direction, such that the fluid medium circulates continuously and in a closed loop. The circulation is repeated the required number of times until the required level of disinfection of the fluid medium is obtained. It is not shown in details, but should be appreciated that inside the reservoir is provided at least one couple of flat electrodes 20, 22, which are electrically connected to the source of electrical power by corresponding power lines 24, 26. For the sake of simplicity it is depicted in FIG. 1, that reactor vessel is open from one end in order to show electrodes within the reactor vessel. One should appreciate, however, that in reality the reactor vessel comprises a box, closed from its all sides and that the fluid medium enters the interior of reactor vessel and exits therefrom via respective ports, as will be shown further.

One should also appreciate that the system of the present invention is not necessary operates continuously and in a closed cycle. It can function in a periodical (batch) manner as well, i.e. after each period of treatment the disinfected fluid medium can be evacuated into a dedicated reservoir instead of reservoir 12 and the treatment cycle then would be resumed.

In FIG. 2 is shown a photograph of one embodiment of reactor vessel 14. As one can see the reactor vessel has a box-like housing configured and dimensioned preferably as rectangular parallelepiped formed by two couples of lateral walls and by a couple of oppositely situated end walls. The housing is made from electrically non-conductive material, e.g. from a durable plastic material.

The walls constituting one pair of lateral walls are designated by respective reference numerals 28, 30 and the opposite end walls are designated by respective reference numerals 32, 34. It can be seen that lateral wall 28 is in fact an upper wall of the housing, while lateral wall 30 is a side wall. On each end wall of the housing is arranged a port for passing the fluid medium to be treated, such that if the fluid medium is displaced clockwise, on the left end wall 32 thereof is provided an entrance port 36 and on the right end wall 34 is provided an exit port 38. It is preferable that the ports are not aligned, i.e. the entrance port would be situated lower than the exit port.

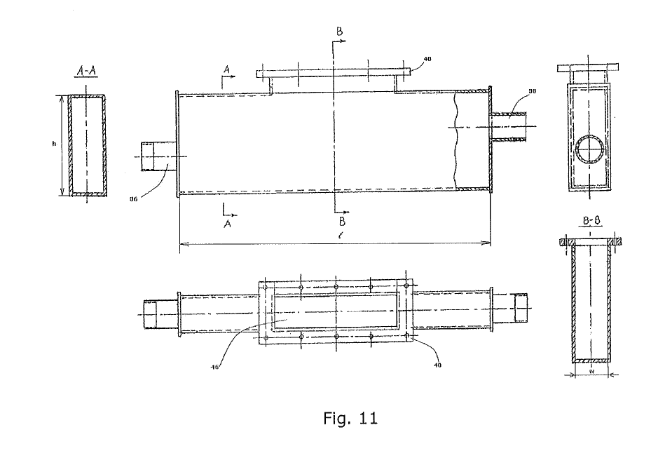

The main dimensions of the reactor vessel and in particular height and length of its walls and diameter of its ports are selected in order to allow the required flow rate of the fluid medium through the reactor vessel as might be required by the treatment conditions and the required capacity of the system. The main dimensions will be detailed further with reference to FIG. 11.

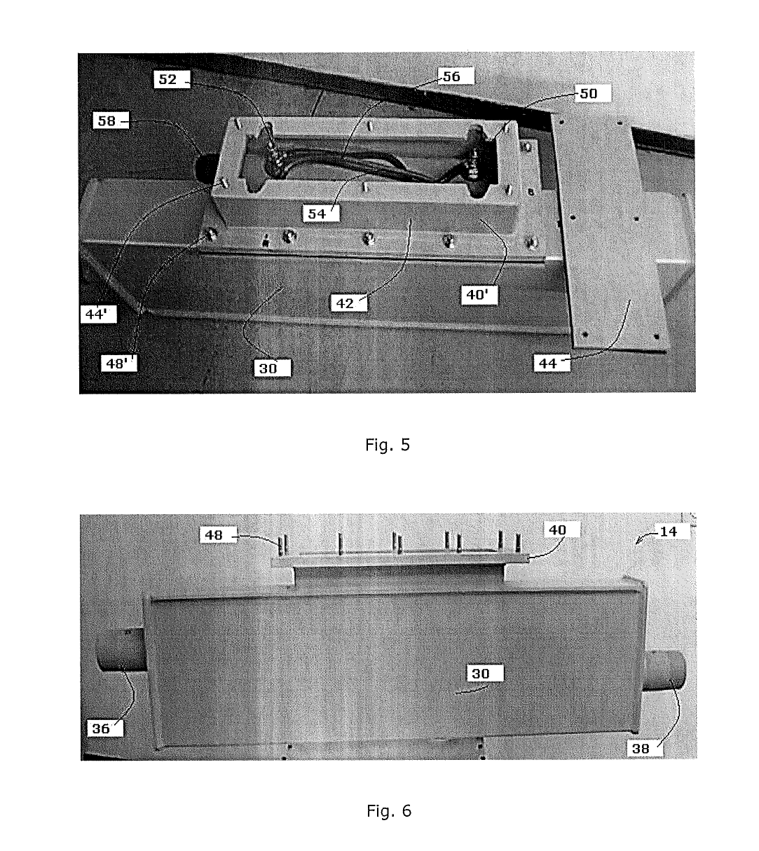

In FIG. 2 it can be seen also that on the upper wall there is provided a flange 40, defining an opening through which interior of reactor vessel can be accessed. To this flange is removably connected a box like receptacle 42, closed by a removable cover 44. The purpose of this receptacle is to provide a room for the electrical components required for electrical connection between the electrodes situated within the housing and the electrical power lines, situated outside of the housing. This arrangement will be explained in more details with reference to FIG. 5.

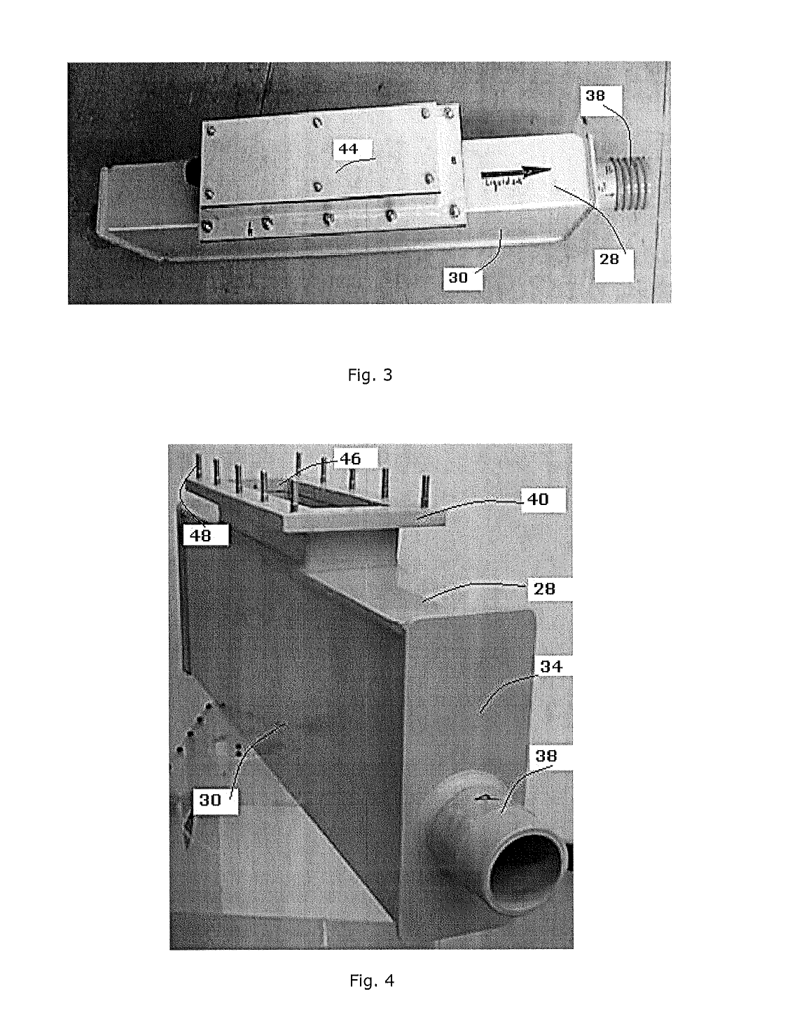

Referring now to FIGS. 3 and 4 there are shown additional view of reactor vessel, in which the already mentioned elements are designated by the same reference numerals.

In FIG. 4 one can see the housing of the reactor vessel, which upper part is shown without receptacle 42. Flange 40 is seen, which defines an opening 46 for access to the housing's interior. Plurality of bolts 48 are distributed on the flange so as to enable alignment and securing of receptacle on the flange.

With reference to FIG. 5 it is shown receptacle 42, removably attached to the flange of the housing by virtue of a corresponding flange 40′, provided on the lower wall of the receptacle. It can be appreciated that once receptacle 42 is attached to the housing it provides a closure for the housing since its lower wall closes the access opening. The receptacle is secured on the housing by plurality of nuts 48′ screwed on bolts 48. The receptacle is shown without upper cover 44 and one can see how wires 54, 56 are screwed on pins of the electrodes by respective nuts 50, 52. Bolts 44′ are provided for detachable securing cover 44. A port 58 is provided on one lateral side of the receptacle. Through this port pass respective power line cables (not shown), which provide electrical connection between the electrodes and the source of electrical power.

One can appreciate that by virtue of removable arrangement of receptacle 42 on the housing as well as by virtue of detachable cover 44 an easy, fast and convenient access to conductor pins or to the housing's interior is provided as might be required for inspection, maintenance or replacement of the electrodes.

In FIG. 6 is depicted another view of the reactor vessel. As in the previous figures the similar elements are designated by the same numerals.

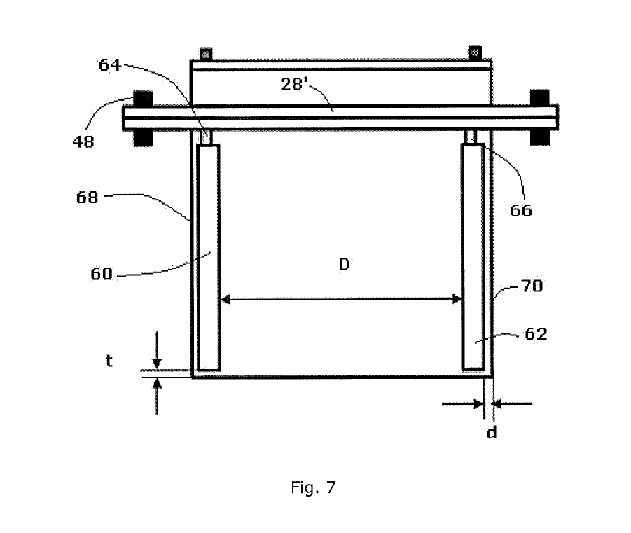

In FIG. 7 is schematically shown cross section view of an embodiment of the reactor vessel. As previously the same reference numerals designate similar elements. Lower wall of the receptacle is screwed to bolts 48 of flange 40 by plurality of nuts such that it constitutes a closure for the interior of the housing. Within the housing is located at least one pair of electrodes 60, 62 rigidly connected to respective conductor pins 64, 66. The conductor pins protrude through the upper walls such that their upper ends are available for electrical connection with respective power lines. The electrodes are made from electrically conductive material, e.g. from steel plates, having thickness 0.5-20 mm depending on the size of the housing.

When reactor vessel is assembled the electrodes are located within the housing being immersed into fluid medium to be treated. The treatment takes place when electrical power with required parameters is applied to electrodes from source 16 through power lines 24, 26 such that alternating electric current passes through the fluid medium. The electrodes are preferably flat and they are positioned inside the housing parallel to respective lateral walls 68, 70.

It can be seen that electrodes are separated from each other by a distance D such that there is provided a small interval d between the electrodes and the lateral walls. In practice this distance is about 0.1-1 mm, depending on the size of reactor vessel. The electrodes are preferably configured as rectangular plates defined by a length dimension L, by a height dimension H and by a surface area S.

It will be presented further an analytical expression which can be used for defining the surface area of the electrodes depending on electrical parameters of the treatment, as well as on the treatment time and flow rate of the fluid medium. The electrodes are situated within the housing such that when the closure is secured on the flange of the housing there is provided a small distance t between the electrodes and a bottom wall of the housing. In practice this distance is 1-5 mm.

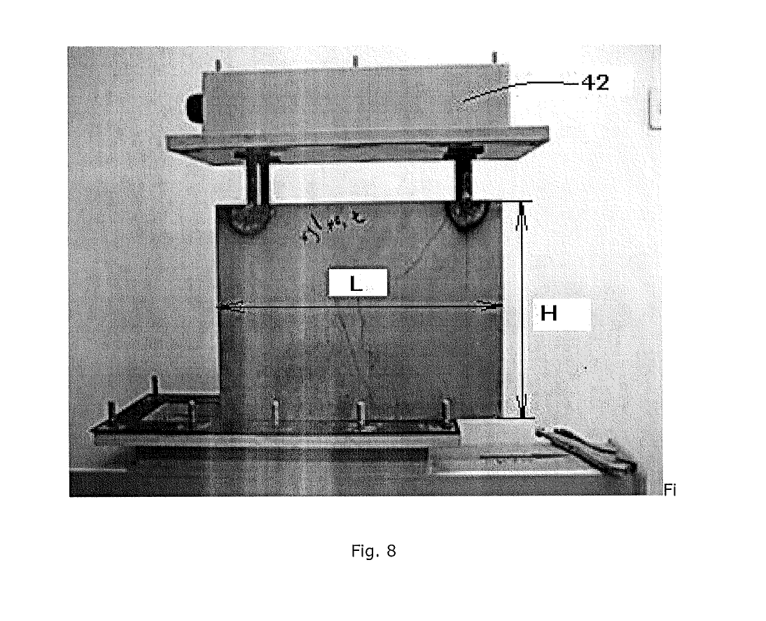

Referring now to FIG. 8 there is seen an embodiment of the reactor vessel. The receptacle with electrodes is shown separate from flange 40 of the housing. The receptacle and the electrodes constitute single, modular assembly, which can be easily separated from the housing such that inspection of the electrodes would be possible. Each of the electrodes is connected to a respective couple of conductor pins, for example by welding. The pins serve for conducting electrical current from the source of power to the electrodes after they are secured in the receptacle. Only one electrode that is designated 62 is seen as well as three conductor pins 64, 64′, 66. It should be appreciated that second electrode is situated behind the electrode 62 and therefore is not seen. It should be also appreciated that the length dimension L of the electrodes is less than the length of the access opening defined by flange 40, such that easy evacuation of the electrodes from the housing or their placement into the housing would be possible.

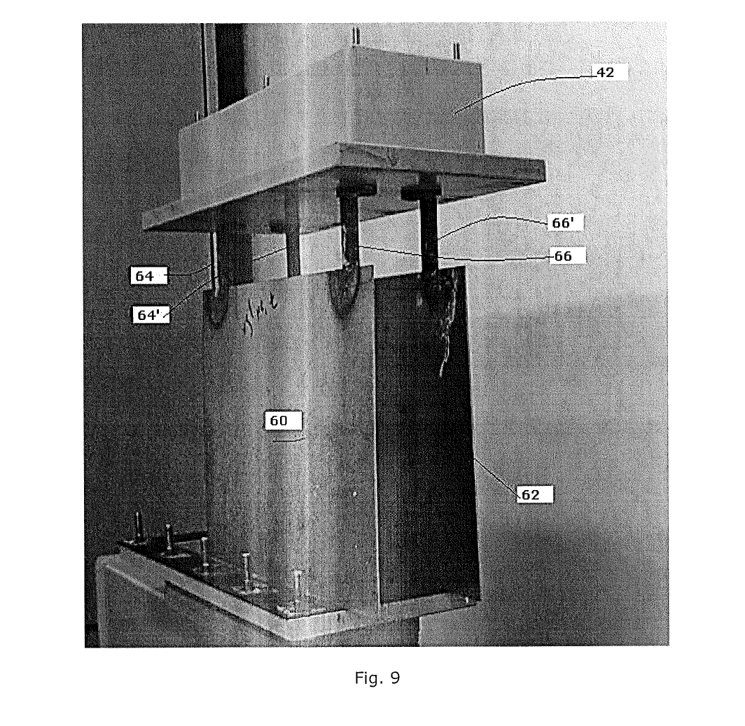

With reference to FIG. 9 it is shown another view of the modular assembly when it has been separated from the housing. The assembly comprises at least one pair of flat electrodes attached to the receptacle. In this view both electrodes 60, 62 as well as their corresponding conductor pins 64, 64′, 66, 66′ are seen.

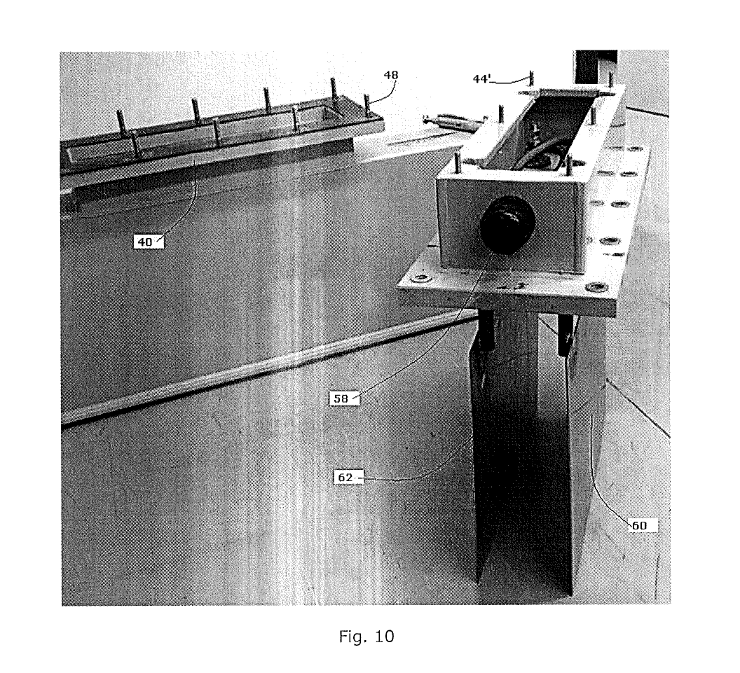

In FIG. 10 is depicted the same modular assembly when it is shown from the opposite end such that port 58 is seen as well.

In FIG. 11 is depicted schematically side view, end view and top view of the reactor vessel as well as its two cross-sectional views taken along arrows A-A and B-B. Ports 36, 38 are seen, which are not in alignment.

In practice interior of the reactor vessel is configured as rectangular parallelepiped having the following main dimensions: length dimension l of about 1010 mm, height dimension h of about 316 mm and width dimension w of about 112 mm. Flange 40 defines access opening 46 intended for evacuation from or placement into reactor vessel of the electrodes. The access opening has rectangular configuration.

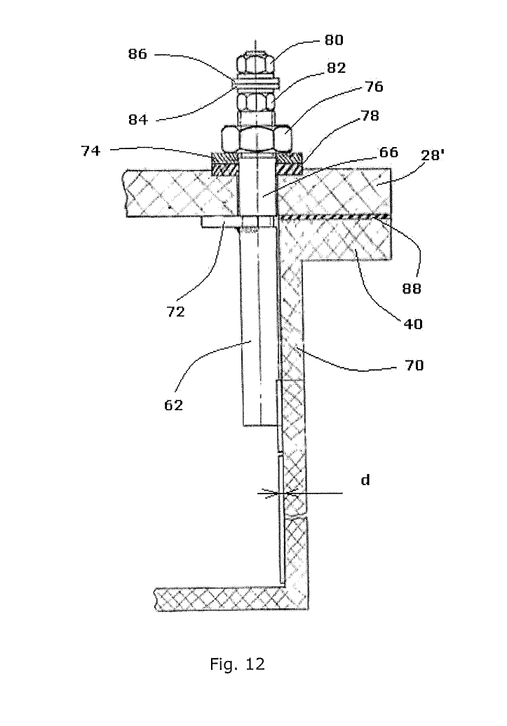

Referring now to FIG. 12 it is shown a fragment of an embodiment of the reactor vessel, in which conductor pins are connected to lower wall of the receptacle. One should appreciate that despite there is shown and will be explained only connection of one electrode the same explanation refers to the rest of the electrodes.

Passing through wall 28′ conductor pin 66 is seen, which is secured on the wall 28′ by a lower washer 72, an upper washer 74 and a fixing nut 76. Situated between wall 28′ and washer 74 an insulating ring 78 is provided for electrical insulation. A couple of connecting nuts 80, 82 screwed on the upper part of the conductor pin are seen. The nuts secure an end of electrical cable (not shown) between a couple of washers 84, 86.

A sealing gasket 88 is provided between removable closure 28′ and flange 40 for sealing the housing's interior after the closure is put on the flange and secured.

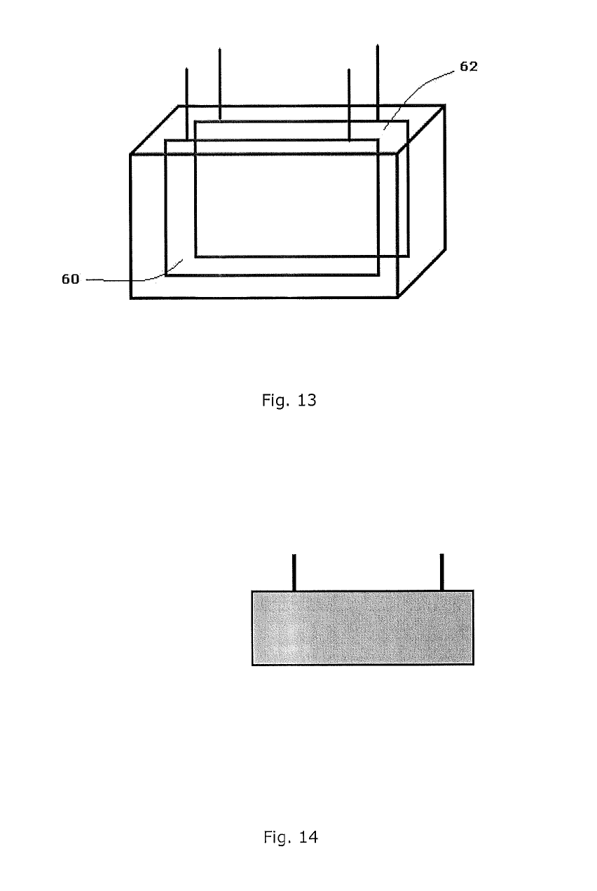

Referring now to FIG. 13 it is shown very schematically how a couple of flat electrodes 60, 62 is located inside reactor vessel, while each electrode is directed parallel to lateral walls of the housing. Protruding from the electrodes respective conductor pins are also seen. By virtue of the present invention the electrodes could be easy and conveniently either removed from the housing together with the cover as a single, modular unit, or retrofitted back inside the housing after inspection and maintenance.

If required the electrodes can be easily and conveniently replaced before returning the modular unit back to the housing.

In FIG. 14 is shown the disposition of conductor pins on an upper edge of a flat removable electrode.

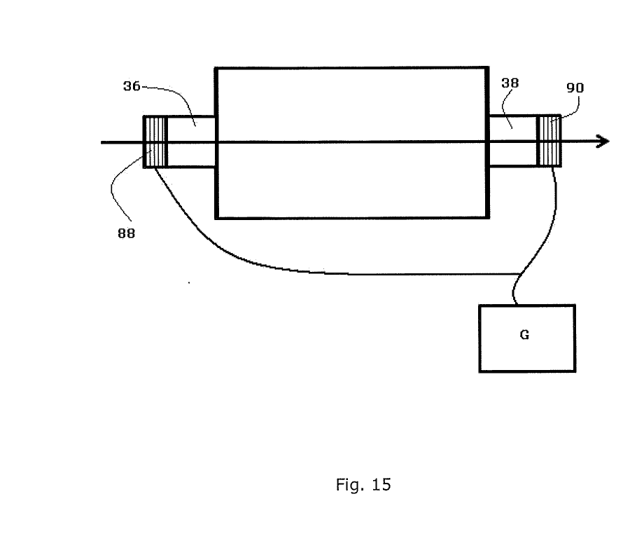

Now with reference to FIGS. 15-18 it will be explained how the electrodes of the reactor vessel could be electrically connected to the ground in various embodiments of reactor vessel of the present invention.

In FIG. 15 is shown schematically an embodiment of reactor vessel, in which grounding of the electrodes is provided by virtue of a couple of electrically conductive rings 88, 90, which are attached to respective ports 36, 38 and are electrically connected to the ground G.

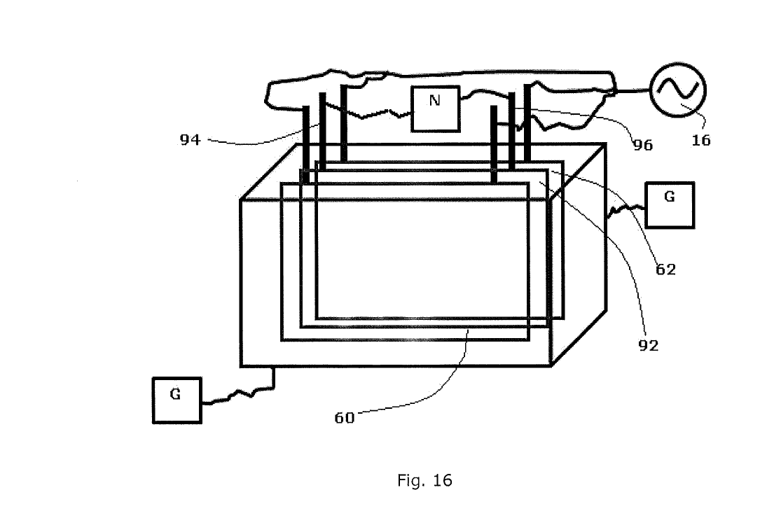

In FIG. 16 is shown schematically an embodiment of the reactor vessel, in which there is provided a flat electrode 92, situated between electrodes 60, 62. In this embodiment electrodes 60, 62 are working electrodes and electrode 92 is an auxiliary electrode, which is grounded. The auxiliary electrode is provided with a couple of conductor pins 94. 96. Source 16 is electrically connected to conductor pins of working electrodes, while the housing of reactor vessel is connected to ground G, while conductor pins 94, 96 of the auxiliary electrode are connected to a neutral N.

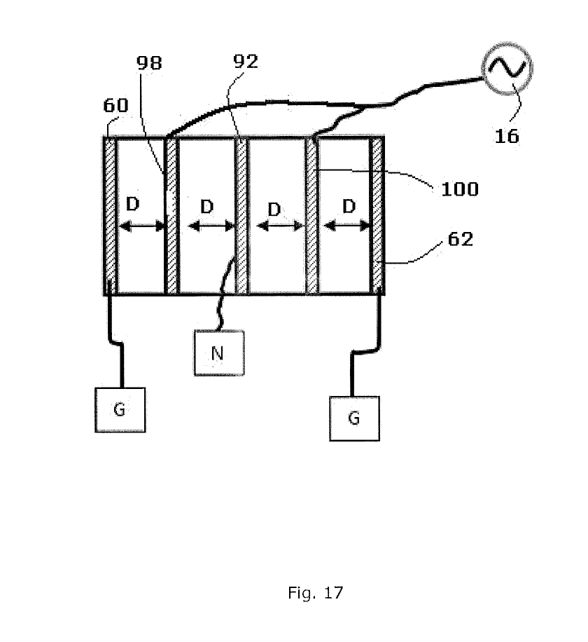

In an embodiment shown in FIG. 17 there is shown an embodiment, in which there are employed two couples of electrodes 60, 62 and 98, 100. Electrodes 60, 62 are connected to the ground G, while electrodes 98, 100 are connected to the source 16 and thus are working electrodes. In the middle part of the housing, situated between working electrodes 98, 100 there is provided an auxiliary electrode 92. Each of the electrodes 60, 62, 98, 100 as well as auxiliary electrode 92 is situated within the housing in such a manner that it is separated from the adjacent electrode by the same distance.

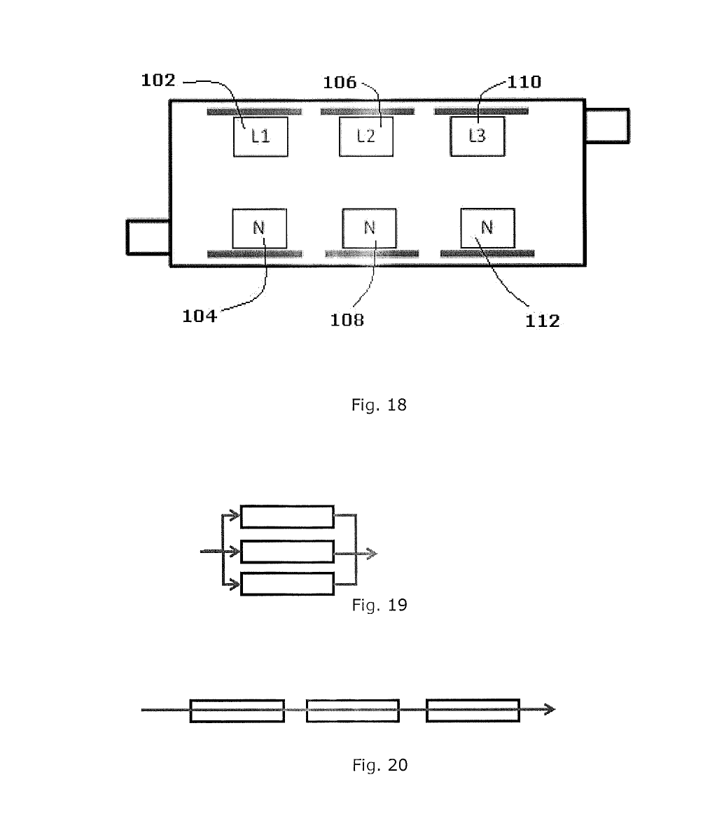

In an embodiment seen in FIG. 18 there is shown schematically how tree couples of working electrodes within reactor vessel can be electrically connected to one phase, two phases or thee phases in parallel. In this arrangement working electrodes 102, 104 of the first pair are electrically connected respectively to phase one (L1) and to neutral (N). Working electrodes 106, 108 of the second pair are electrically connected respectively to phase two (L2) and to neutral (N). Working electrodes 110, 112 of the third pair are electrically connected respectively to phase three (L3) and to neutral (N).

In FIGS. 19, 20 there is shown schematically how the system of the present invention may comprise more than one reactor vessel, connected either in parallel, as seen in FIG. 19, or in series, as seen in FIG. 20.

In accordance with the present invention it has been empirically revealed that for easy, convenient and fast evacuation of flat working electrodes from the housing and at the same time for efficient treatment of biologically contaminated fluid medium in the reactor vessel the above mentioned parameters D and S electrodes should be calculated by the following formulae:

$$\begin{matrix}D = \frac{{V}_{0}}{{ρ}_{0} \cdot {I}_{0}} = \frac{{V}_{0}}{{ρ}_{0} \cdot {j}_{0} \cdot S} & ( 1 ) \\ S = \frac{{T}_{0} \cdot {Q}_{0}}{D} = {( \frac{{T}_{0} \cdot {Q}_{0} \cdot {ρ}_{0} \cdot {j}_{0}}{{V}_{0}} )}^{\frac{1}{2}} & ( 2 )\end{matrix}$$

wherein in the above formulae

V₀ is given voltage which is supplied by the source of electrical power during the treatment,

I₀ is electrical current which is supplied by the source of electrical power during the treatment,

j₀ is density of electrical current needed for the treatment, I₀/S,

T₀ is treatment time,

Q₀ is flow rate of the waste waters during the treatment,

ρ₀ is electrical resistance of the waste waters to be treated.

After calculating the surface S one can calculate the length dimension L and the height dimension H of the electrodes.

Now it will be shown how the system and reactor vessel of the present invention were used in practice for treatment of biologically contaminated fluid medium. The treatment was carried out for reduction the amount of pathogens, phosphorus and odor from industrial waste waters and thus for improving of at least some of the environmental parameters of the fluid medium. The system was provided with a source of electrical power capable to supply alternating voltage of 110 or 220 volts. The system control instrumentation was equipped with a PLC (Programmed Logical Controller) and with a current transducer for comparing values of the current flowing through the electrodes. The system instrumentation comprised also a SSR (Solid State Relay) for changing the current and a frequency controller for changing the flow rate of the fluid medium.

The electrical parameters were varied during the treatment session such that current density J was kept between 0.055 A/cm² and 0.1 A/cm².

Construction parameters of reactor vessel, like electrodes surface area S, length dimension L and height dimension H as well as distance D between electrodes were calculated by formulae (1) and (2) for given electrical parameters, at constant flow rate of 6.6 m³/hour and for a given electrical resistance of the fluid medium. The results are summarized in non-limiting table 1 below.

TABLE 1

| | | H, | | D, | I, | J, | E, | |
|---|---|---|---|---|---|---|---|---|
| Example | L, cm | cm | S, cm² | cm | amper | a/cm² | v/cm | V, volt |
| 1 | 62 | 16 | 1000 | 15 | 100 | 0.1 | 14.6 | 220 |
| 2 | 33 | 30 | 990 | 15 | 80 | 0.08 | 2.6 | 40 |
| 3 | 30 | 30 | 900 | 7 | 50 | 0.055 | 15.7 | 110 |

By virtue of the above described system and reactor vessel it was possible to reduce environmental parameters of the fluid medium as well as amount of pathogens, phosphorus and nitrogen as seen in non-limiting table 2 below.

TABLE 2

| Parameter | Pathogens | BOD | TSS | P | N |
|---|---|---|---|---|---|
| Reduction | >99% | ~75% | ~50% | ~90% | ~50% |

From the obtained results it is evident that the system and reactor vessel according to the present invention have improved properties in terms of efficiency of the treatment and of convenience in exploitation.

It should be appreciated that the present invention is not limited by the above described embodiments and that one ordinarily skilled in the art can make changes and modifications without deviation from the scope of the invention as will be defined below in the appended claims.

In one alternative embodiment the housing can be made from electrically conductive, e.g. metallic material and coated by a non-conductive coating.

In the embodiment presented in FIG. 7 the electrodes comprise two separate rectangular plates, made of conductive material. One should appreciate that the electrodes could be also accomplished as integral parts of lateral walls, provided that they are made of conductive material. In such an embodiment the remaining portions of the walls, which are not the electrodes, would be coated by a non-conductive coating.

Furthermore, the electrodes should not be merely rigidly connected to the conductor pins. The electrodes not necessarily have to be flat. One could contemplate a situation, in which the electrodes are configured as graphite rods arranged as an array of rods, confined within a cassette. A couple of such cassettes could be located within the housing, while the cassettes would be separated by the distance D and the electrodes would have the surface area S. The electrodes would be provided with detachable copper cups for electrical connecting to the conductor pins.

It should also be appreciated that features disclosed in the foregoing description, and/or in the foregoing drawings, and/or examples, and/or tables, and/or following claims both separately and in any combination thereof, be material for realizing the present invention in diverse forms thereof.

When used in the following claims the terms “comprise”, “contain”, “have” and their conjugates mean “including but not limited to”.

1. A system for electrical treatment of a fluid medium, containing contaminating biological matter, the system comprising:
a reactor vessel,
a source of electrical power and appropriate instrumentation for controlling parameters of the treatment, said source and said instrumentation being electrically connected to the reactor vessel,
a reservoir with the fluid medium to be treated,
a displacement means for forcible displacing the fluid medium from the reservoir to the reactor vessel, wherein
said reactor vessel is provided with a housing being closed from one side thereof by a removable closure carrying at least one couple of electrodes, which are electrically connected to the source of electrical power, wherein upon securing the removable closure on the housing the electrodes are separated by a distance D and each of the electrodes has a surface area S, while the distance D and the surface area S are calculated by the following formulae:
$$\begin{matrix}D = \frac{{V}_{0}}{{ρ}_{0} \cdot {I}_{0}} = \frac{{V}_{0}}{{ρ}_{0} \cdot {j}_{0} \cdot S} & ( 1 ) \\ S = \frac{{T}_{0} \cdot {Q}_{0}}{D} = {( \frac{{T}_{0} \cdot {Q}_{0} \cdot {ρ}_{0} \cdot {j}_{0}}{{V}_{0}} )}^{\frac{1}{2}} & ( 2 )\end{matrix}$$
wherein in the above formulae
V₀ is given voltage which is supplied by the source of electrical power during the treatment,
I₀ is electrical current which is supplied by the source of electrical power during the treatment,
j₀ is density of electrical current needed for the treatment, I₀/S,
T₀ is treatment time,
Q₀ is flow rate of the waste waters during the treatment,
ρ₀ is electrical resistance of the waste waters to be treated,
and the closure is adapted for assembling with and disassembling from the housing such that the closure could be conveniently separated from the reactor vessel together with the electrodes to provide easy access to the electrodes for inspection, replacement, repair, cleaning or for other type of maintenance.

2. The system as defined in claim 1, in which said electrodes are provided with conductor pins rigidly connected to the electrodes, said pins are adapted for electrical connecting the electrodes with the source of electrical power via appropriate cable power lines.

3. The system as defined in claim 2, in which said closure comprises a receptacle defining a room for the conductor pins and for the cable power lines.

4. The system as defined in claim 1, in which said displacement means comprises a pump.

5. The system as defined in claim 4, in which said fluid medium is selected from the group consisting of industrial waste waters, agricultural waste waters, municipal sewage, waste waters originating from slaughter houses, waste waters originating from mining installations, fracturing waste waters, food industry waste waters, pharmaceutical industry waste waters and cosmetic industry waste waters.

6. A reactor vessel for treatment of a fluid medium by passing alternating current therethrough, said reactor vessel comprising:
a housing provided with an entrance port and an exit port,
at least one couple of electrodes, which are electrically connectable with a source of electrical power, wherein said housing is provided with an access opening for insertion into or evacuating from the housing of said at least one couple of electrodes,
a removable closure carrying the at least one couple of electrodes, the arrangement being such that upon attaching the closure to the housing said electrodes are separated by a distance D and each of the electrodes is defined by a surface area S, while the distance D and the surface area S are calculated by the following formulae:
$$\begin{matrix}D = \frac{{V}_{0}}{{ρ}_{0} \cdot {I}_{0}} = \frac{{V}_{0}}{{ρ}_{0} \cdot {j}_{0} \cdot S} & ( 1 ) \\ S = \frac{{T}_{0} \cdot {Q}_{0}}{D} = {( \frac{{T}_{0} \cdot {Q}_{0} \cdot {ρ}_{0} \cdot {j}_{0}}{{V}_{0}} )}^{\frac{1}{2}} & ( 2 )\end{matrix}$$
wherein in the above formulae
V₀ is given voltage which is supplied by the source of electrical power during the treatment,
I₀ is electrical current which is supplied by the source of electrical power during the treatment,
j₀ is density of electrical current needed for the treatment, I₀/S,
T₀ is treatment time,
Q₀ is flow rate of the waste waters during the treatment,
ρ₀ is electrical resistance of the waste waters to be treated,
the closure is adapted to be conveniently separated from and attached to the reactor vessel together with the electrodes to provide access to the electrodes for their inspection, replacement, repair, cleaning or for other type of maintenance.

7. The reactor vessel as defined in claim 6, in which said housing is configured as rectangular parallelepiped, which is delimited by a couple of lateral walls, by a bottom wall, by an upper wall and by two opposite end walls and said entrance port and said exit port is located on a respective end wall.

8. The reactor vessel as defined in claim 7, in which the entrance port is not aligned with the exit port and said access opening is on the upper wall.

9. The reactor vessel as defined in claim 8, in which said electrodes are configured as rectangular plates made from an electrically conductive material and said electrodes are directed parallel to the lateral walls of the housing.

10. The reactor vessel as defined in claim 9, in which said electrodes are made from a material, selected from the group consisting of metallic materials and non-metallic materials.

11. The reactor vessel as defined in claim 9, in which each of said electrodes is rigidly connected to at least one couple of conductor pins protruding from the housing through the enclosure and upper ends of conductor pins are electrically connected to the source of electric power.

12. The reactor vessel as defined in claim 6, in which the access opening is configured as a rectangle delimited by a flange.

13. The reactor vessel as defined in claim 7, in which the closure comprises a receptacle having a bottom wall connectable to the flange of the housing.

14. The reactor vessel as defined in claim 12, in which upper ends of the conductor pins protrude through the bottom wall and said receptacle provides a room for the upper ends of conductor pins as well for the power lines.

15. The reactor vessel as defined in claim 14, in which the conductor pins are rigidly connected to electrodes and said power lines are removably connected to the conductor pins.

16. The reactor vessel as defined in claim 6, in which said housing is grounded and there is provided an auxiliary electrode, which is electrically connected to a neutral line.

17. The reactor vessel as defined in claim 16, in which said entrance port and said exit port is provided with a respective ring made from an electrically conductive material and said ring is grounded.

18. The reactor vessel as defined in claim 16, comprising two pair of electrodes, one pair of electrodes being working electrodes electrically connected to the source of alternating voltage and the second pair of electrodes being grounded.

19. The reactor vessel as defined in claim 18, in which said receptacle is provided with a port for passing the power lines.

20. The reactor vessel as defined in claim 18, in which said housing is made from electrically non-conductive material.
